(19) United States
(12) Patent Application Publication
(10) Pub. No.: US 2020/0160882 A1
(43) Pub. Date: May 21, 2020

(54) Audio Detection Device and Audio Detection Method

(71) Applicant: U-MEDIA Communications, Inc., Hsinchu (TW)

(72) Inventor: Yi-Wen Liu, Hsinchu City (TW)

(21) Appl. No.: 16/223,123

(22) Filed: Dec. 18, 2018

(30) Foreign Application Priority Data
Nov. 20, 2018 (TW) 107141142

(51) Int. Cl. G10L 25/84; G10L 21/0224; H04R 3/04

(52) U.S. Cl. CPC G10L 25/84; G10L 2021/02082; H04R 3/04; G10L 21/0224

(57) ABSTRACT

An audio detection device and an audio detection method are provided. The audio processing device includes a first audio input device, a second audio input device and an audio processing circuit. The first audio input device is utilized for acquiring a first audio signal and converting first audio signal to a first digital audio signal. The second audio input device is utilized for acquiring a second audio signal and converting second audio signal to a second digital audio signal. The second audio input device is disposed close adjacent to a sound source. A distance between second audio input device and sound source is shorter than a distance between first audio input device and sound source. The audio processing circuit is utilized for performing an echo cancellation process on the first digital audio signal according to second digital audio signal so as to generate a digital audio detection signal.

### BACKGROUND OF THE INVENTION

### 1. Field of the Invention

The present invention relates to an audio detection device and audio detection method, and more particularly, to an audio detection device and audio detection method capable of improving audio detection accuracy.

### 2. Description of the Prior Art

With development of technology, speech input and speech recognition is widely applied in electronic products, such as mobile phones, intelligent appliances, smart nursing care robots and voice navigation devices. In a real environment, the speech input and recognition device is often interfered by environmental background noise, thus resulting in a significant decrease in recognition rate and making it difficult to identify the actual sound signal. For example, when the speech input and recognition device is applied in an indoor environment, the sound produced by a speaker of a television or radio is easily introduced into the voice input recognition device and affects the recognition rate of the actual voice input, thereby resulting in a poor user experience. Therefore, how to solve the above mentioned problems has become an important issue in the field.

### SUMMARY OF THE INVENTION

It is therefore a primary objective of the present invention to provide an audio detection device and audio detection method capable of improving audio detection accuracy, in order to resolve the aforementioned problems.

According to an embodiment of the present invention, an audio detection device is disclosed. The exemplary audio detection device comprises an audio detection device, comprising: a first audio input device for acquiring a first audio signal and converting the first audio signal into a first digital audio signal; a second audio input device for acquiring a second audio signal and converting the second audio signal into a second digital audio signal, wherein the second audio input device is disposed close adjacent to a sound source, and a distance between the second audio input device and the sound source is shorter than a distance between the first audio input device and the sound source; and an audio processing circuit for performing an echo cancellation process on the first digital audio signal according to the second digital audio signal so as to generate a digital audio detection signal.

According to an embodiment of the present invention, an audio detection method for an audio detection device is disclosed. The audio detection device comprises a first audio input device a second audio input device, the second audio input device disposed close adjacent to a sound source, and a distance between the second audio input device and the sound source is shorter than a distance between the first audio input device and the sound source. The exemplary audio detection method for an audio detection device comprises utilizing the first audio input device to acquire a first audio signal and convert the first audio signal into a first digital audio signal; utilizing the second audio input device to acquire a second audio signal and convert the second audio signal into a second digital audio signal; and performing an echo cancellation process on the first digital audio signal according to the second digital audio signal so as to generate a digital audio detection signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an embodiment of the present invention.

FIG. 2 is a flow diagram of a procedure according to an embodiment of the invention.

FIG. 3 is a schematic diagram of the audio processing circuit shown in FIG. 1 according to an embodiment of the invention.

FIG. 4 is a schematic diagram of the electronic system applied in an indoor environment according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

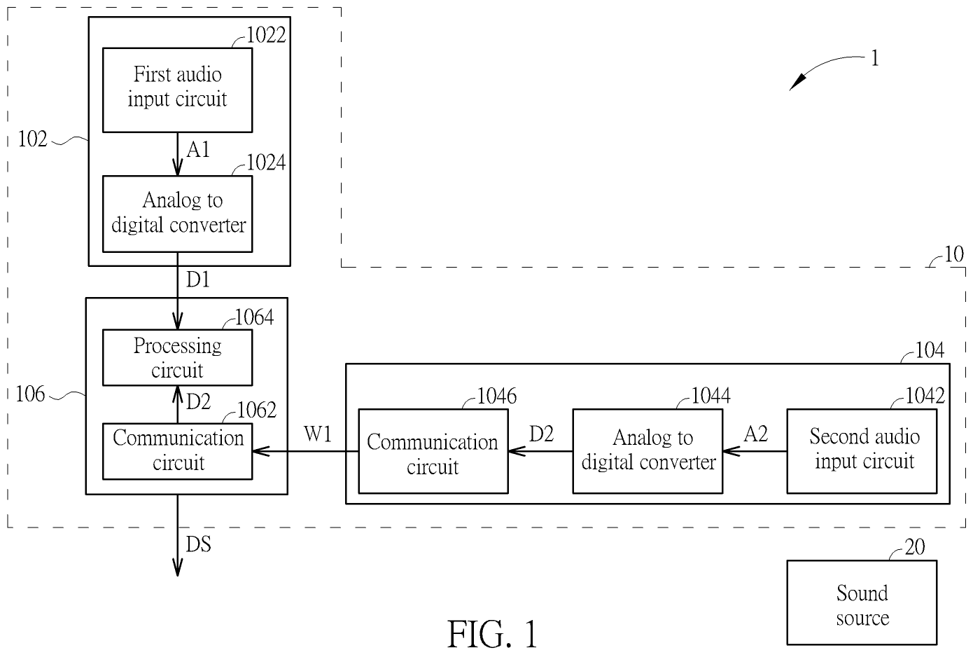

Please refer to FIG. 1, which is a schematic diagram illustrating an electronic system 1 according to an embodiment of the present invention. The electronic system 1 includes an audio detection device 10 and a sound source 20. The audio detection device 10 includes a first audio input device 102, a second audio input device 104 and an audio processing circuit 106. The second audio input device 104 is disposed close adjacent to the sound source 20. A distance between the second audio input device 104 and the sound source 20 is shorter than a distance between the first audio input device 102 and the sound source 20. The first audio input device 102 includes a first audio input circuit 1022 and an analog to digital converter 1024. The first audio input circuit 1022 is utilized for acquiring a first audio signal A1. The analog to digital converter 1024 is coupled to the first audio input circuit 102 for converting the first audio signal A1 into the first digital audio signal D1.

The second audio input device 104 includes a second audio input circuit 1042, an analog to digital converter 1044 and a communication circuit 1046. The second audio input circuit 1042 is disposed close adjacent to the sound source 20. That is, a distance between the second audio input circuit 1042 and the sound source 20 is shorter than a distance between the first audio input circuit 1022 and the sound source 20. The second audio input circuit 1042 is utilized for acquiring a second audio signal A2. The analog to digital converter 1044 is coupled to the second audio input circuit 1042 for converting the second audio signal A2 into the second digital audio signal D2 and transmitting the second digital audio signal D2 to the communication circuit 1046. The communication circuit 1046 is utilized for converting the second digital audio signal D2 into a wireless transmission signal W1 and transmitting the wireless transmission signal W1 through wireless communications. Therefore, the wireless transmission signal W1 is transmitted to the audio processing circuit 106 through wireless communications.

The audio processing circuit 106 includes a communication circuit 1062 and a processing circuit 1064. The communication circuit 1062 is utilized for receiving a wireless transmission signal W1 transmitted by the second audio input device 104 and converting the wireless transmission signal W1 into the second digital audio signal D2. The processing circuit 1064 is coupled to the communication circuit 1062 and the analog to digital converter 1024 for performing an echo cancellation process on the first digital audio signal D1 according to the second digital audio signal D2 so as to generate the digital audio detection signal DS. In addition, the analog to digital converter 1024 can direct transmit the first digital audio signal D1 to the processing circuit 1064. The analog to digital converter 1024 can also transmit the first digital audio signal D1 to the communication circuit 1062 and the communication circuit 1062 provides the first digital audio signal D1 to the processing circuit 1064.

The second audio input device 104 can be mounted on the sound source 20. For example, the second audio input device 104 can be mounted on a casing of the sound source 20. The second audio input device 104 can also be disposed around the sound source 20. For example, the sound source 20 can be a speaker of an electronic device, such as a speaker of a television, a radio or a home appliance, but not limited thereto. The speaker can generate and output sound according to a sound signal provide by an electronic device. For example, the sound source 20 can also be a human, an animal, a musical instrument, a machine, a natural environment, or any other object capable of producing sound. The first audio input circuit 1022 and the second audio input circuit 1042 can be microphones, but not limited thereto. The second audio input circuit 1042 can be a directional microphone and point toward to the sound source 20, such that the second audio input circuit 1042 can more clearly acquire the sound produce by the sound source 20 and effectively reduce the interference of the ambient background sound. The processing circuit 1064 of the audio processing circuit 106 can be a digital signal processor (DSP) chip, but not limited thereto. In other words, the audio detection device 10 of the present invention can receive the sound input and effectively reduce the interference of the sound of the sound source 20 with the actual sound input.

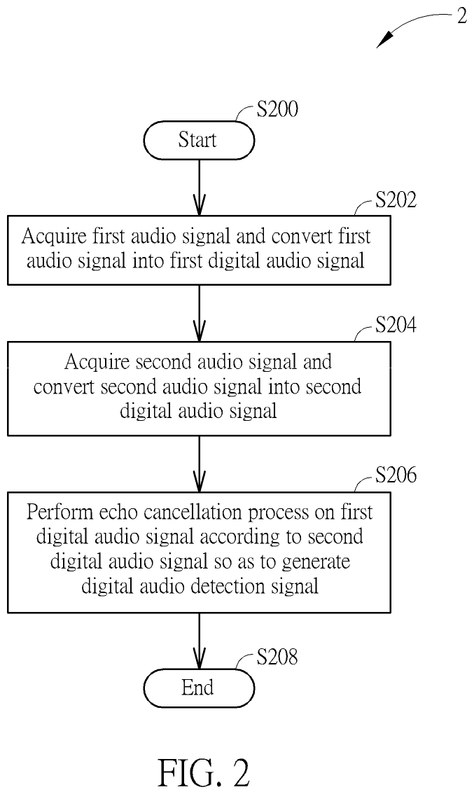

For an illustration of the operations of the electronic system 1, please refer to FIG. 2. FIG. 2 is a flow diagram of a procedure 2 according to an exemplary embodiment of the invention. The flow diagram in FIG. 2 mainly corresponds to the operations on the electronic system 1 shown in FIG. 1. The procedure 2 includes the following steps:

Step S200: Start.

Step S202: Acquire first audio signal and convert first audio signal into first digital audio signal.

Step S204: Acquire second audio signal and convert second audio signal into second digital audio signal.

Step S206: Perform echo cancellation process on first digital audio signal according to second digital audio signal so as to generate digital audio detection signal.

Step S208: End.

According to the procedure 2, in Step S202, when the electronic system 1 is operating, the first audio input circuit 1022 acquires a first audio signal A1 and transmits the first audio signal A1 to the analog to digital converter 1024. The digital converter 1024 converts the first audio signal A1 into a first digital audio signal D1. The first digital audio signal D1 is transmitted to the audio processing circuit 106. The first audio signal A1 may include a desired audio input and environmental (also called ambient) background sounds (e.g., sound produced by the sound source 20).

In Step S204, the second audio input circuit 1042 is acquires a second audio signal A2 and transmits the second audio signal A2 to the analog to digital converter 1044. The analog to digital converter 1044 converts the second audio signal A2 into a second digital audio signal D2 and transmits the second digital audio signal D2 to the communication circuit 1046. The communication circuit 1046 converts the second digital audio signal D2 into a wireless transmission signal W1 and transmits a wireless radio signal corresponding to the wireless transmission signal W1 so as to transmit the wireless transmission signal W1 to the audio processing circuit 106 through wireless communications. The second audio signal A2 may include the sound produced by the sound source 20. In an embodiment, the second audio input device 104 can communicate with the audio processing circuit 106 via wireless connections for transmitting the wireless transmission signal W1. For example, the communication circuit 1046 may utilize the wireless transmission technologies such as the Bluetooth, Wi-Fi, infra-red ray or Radio Frequency Identification (RFID) to communicate with the audio processing circuit 106 for transmitting the wireless transmission signal W1, but not limited thereto.

In Step S206, the audio processing circuit 106 can perform an echo cancellation process on the first digital audio signal D1 according to the second digital audio signal D2 so as to generate the digital audio detection signal DS. In more details, after receiving the wireless transmission signal W1, the communication circuit 1062 converts the wireless transmission signal W1 into the second digital audio signal D2 and transmits the second digital audio signal D2 to the processing circuit 1064. The processing circuit 1064 performs an echo cancellation process on the first digital audio signal D1 according to the second digital audio signal D2 so as to generate the digital audio detection signal DS.

Because the sound produced by the sound source 20 is unwanted noise, the audio processing circuit 106 can invert and delay the second digital audio signal D2 and add the inverted and delayed second digital audio signal D2 and to the first digital audio signal D1, so as to eliminate components of the second digital audio signal D2 from the first digital audio signal D1 and obtain a clean digital audio detection signal DS eliminating the noise of the sound source 20. The audio processing circuit 106 can also perform an echo cancellation process on the first digital audio signal D1 according to the second digital audio signal D2 so as to generate a digital audio detection signal DS by using echo cancellation algorithms or echo cancellation models for eliminating the influence of the sound produced by the sound source 20 in the first digital audio signal D1.

The audio processing circuit 106 can delay the second digital audio signal D2 for a delay time period TD to generate a delayed second digital audio signal D2′ and perform an echo cancellation process on the first digital audio signal D1 according to delayed second digital audio signal D2′ so as to generate the digital audio detection signal DS. The delay time period TD is associated with at least one of a transmission time T1 of transmitting sound from the sound source 20 to the first audio input circuit 1022, a processing time TP1 of converting the first audio signal A1 into the first digital audio signal D1 by the analog to digital converter 1024, a processing time TP2 of converting the second audio signal A2 into the second digital audio signal D2 by the analog to digital converter 1044, a processing time TP3 of converting the second digital audio signal D2 into the wireless transmission signal W1 and emitting a wireless radio signal corresponding to the wireless transmission signal W1 and a processing time TP4 of converting the wireless transmission signal W1 into the second digital audio signal D2. Since the second audio input circuit 1042 is disposed close adjacent to the sound source 20, the transmission time of delivering sound from the sound source 20 to the second audio input circuit 1042 is extremely short and thus can be ignored. Moreover, the signal transmission time of delivering the wireless radio signal corresponding to the wireless radio signal W1 from the communication circuit 1046 to the communication circuit 1062 is extremely short and thus can be ignored. Therefore, the delay time period TD can be obtained according to the follow equation:

TD=(T1+TP1)−(TP2+TP3+TP4) (1)

That is, the delay time period TD is a difference between a sum of the transmission time T1 of transmitting sound from the sound source 20 to the first audio input circuit 1022 and the processing time TP1 of converting the first audio signal A1 into the first digital audio signal D1 by the analog to digital converter 1024 and a sum of the processing time TP2 of converting the second audio signal A2 into the second digital audio signal D2 by the analog to digital converter 1044, the processing time TP3 of converting the second digital audio signal D2 into the wireless transmission signal W1 and emitting a wireless radio signal corresponding to the wireless transmission signal W1 and the processing time TP4 of converting the wireless transmission signal W1 into the second digital audio signal D2. As a result, the accuracy of the sound input and recognition can be improved effectively.

On the other hand, the second audio input device 104 can operate according to a first clock signal and the audio processing circuit 106 can also operate according to the first clock signal. The second audio input device 104 and the audio processing circuit 106 operate based on the same first clock signal. The second audio input device 104 further includes a speaker (not shown in figures). The speaker of the second audio input device 104 is disposed close adjacent to the sound source 20. The speaker of the second audio input device 104 can produce a test sound signal and the communication circuit 1046 can transmit an indication signal indicating that the speaker of the second audio input device 104 has outputted the test sound signal, to the audio processing circuit 106 simultaneously. after the processing circuit 1064 receives the indication signal from the communication circuit 1046 and the first input circuit 1022 receives the test sound signal, the processing circuit 1064 can calculate a transmission time T1 of transmitting sound from the sound source 20 to the first audio input circuit 1022 according to the time point of receiving the test sound signal by the first input circuit 1022. For example, the indication signal indicates that the speaker of the second audio input device 104 is outputted at a first time period of the first clock signal. When receiving the test sound signal, the first input circuit 1022 informs the processing circuit 1064 of receiving the test sound signal and accordingly the processing circuit 1064 determines the test sound signal is received at a second time period of the first clock signal. Further, the processing circuit 1064 calculates a difference between the first time period and the second time period to generate a calculation result. As a result, the calculation result is the transmission time T1 of transmitting sound from the sound source 20 to the first audio input circuit 1022 since the speaker of the second audio input device 104 is disposed close adjacent to the sound source 20.

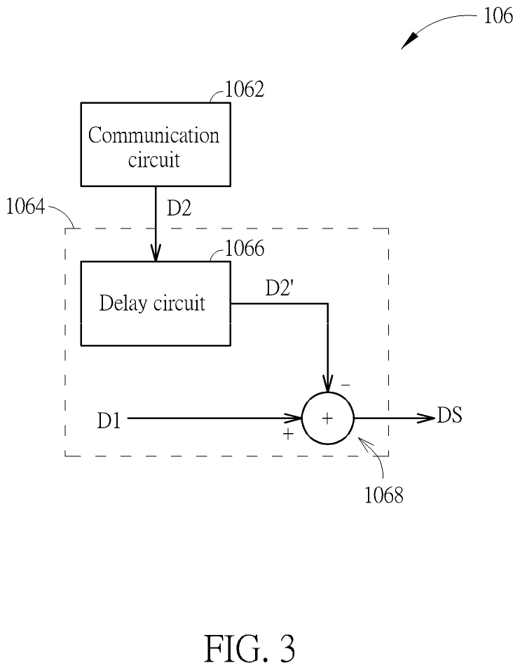

For example, please refer to FIG. 3. FIG. 3 is a schematic diagram of the audio processing circuit 106 shown in FIG. 1 according to an embodiment of the invention. The audio processing circuit 106 includes a delay circuit 1066 and a subtractor 1068. The delay circuit 1066 delays the second digital audio signal D2 for a delay time period TD and outputs a delayed second digital audio signal D2′. The subtractor 1068 subtracts the delayed second digital audio signal D2′ from the first digital audio signal D1 to generate the digital audio detection signal DS. As a result, the subtractor 1068 outputs the digital audio detection signal DS from which the components of the second digital audio signal D2 has been removed, so as to eliminate the unwanted ambient noise sound and retain the normal sound signals for improving sound input accuracy. In other words, the audio detection device 10 of the present invention can receive the sound input and reduce the interference of the sound of the sound source 20 with the actual sound input effectively.

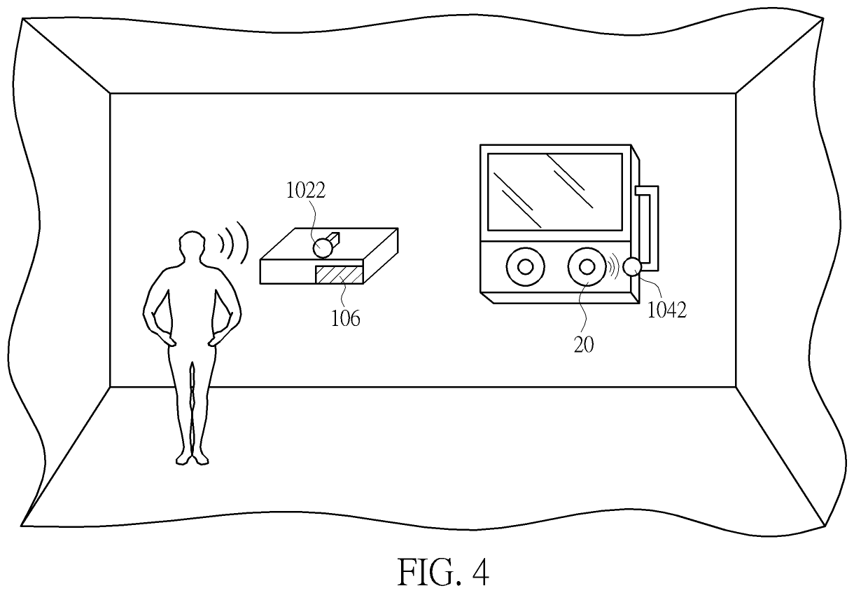

For example, please refer to FIG. 4. FIG. 4 is a schematic diagram of the electronic system applied in an indoor environment according to an embodiment of the present invention. Suppose the sound source 20 is a speaker of a television. As shown in FIG. 4, the second audio input circuit 1042 is mounted on the casing of the television such that the second audio input circuit 1042 is close neighboring the sound source 20 for receiving sound produced by the sound source 20. The user speaks toward the first audio input circuit 1022 of the first audio input device 102. Since the television sound may be more noticeable in the indoor environment, the television sound will significantly interfere with the sound input of the first audio input device 102. Under such a condition, the first audio input circuit 1022 acquires the first audio signal A1. The first audio signal A1 is converted into the first digital audio signal D1 and the first digital audio signal D1 is transmitted to the audio processing circuit 106. The second audio input circuit 1042 acquires the second audio signal A2. The second audio signal A2 is converted into the second digital audio signal D2 and the wireless transmission signal W1. The wireless transmission signal W1 is transmitted to the audio processing circuit 106 through wireless communications. For example, the signal transmission time of delivering the wireless radio signal corresponding to the wireless radio signal W1 from the second audio input device 104 to the audio processing circuit 106 is 0.01 microseconds. The transmission time of transmitting sound from the sound source 20 to the audio processing circuit 106 is 10 milliseconds. As can be seen, the speed of transmitting signals wirelessly is much faster than the speed of sound propagation, the signal transmission time of delivering the wireless radio signal corresponding to the wireless radio signal W1 from the second audio input device 104 to the audio processing circuit 106 can be ignored. Further, the audio processing circuit 106 delays the second digital audio signal D2 for a delay time period TD to generate a delayed second digital audio signal D2′ and performs an echo cancellation process on the first digital audio signal D1 according to delayed second digital audio signal D2′ so as to generate the digital audio detection signal DS. Therefore, the present invention can eliminate the interference of the sound of the sound source 20 with the actual sound input effectively, thus improving sound input accuracy.

In summary, the embodiment of the invention utilizes an audio signal acquired by the audio input device disposed closely neighboring the sound source for performing the echo cancellation operation, so as to eliminate the unwanted ambient noise sound and retain the normal sound signals, thus improving sound input accuracy and user experience. Moreover, the embodiments of the invention do not need to direct connect or communicate with the sound source, and merely need to arrange the audio input device close adjacent to the sound source, thus improving sound input and recognition accuracy.

Those skilled in the art will readily observe that numerous modifications and alterations of the device and method may be made while retaining the teachings of the invention. Accordingly, the above disclosure should be construed as limited only by the metes and bounds of the appended claims.

1. An audio detection device, comprising:
a first audio input device including a first microphone for acquiring a first audio signal including sounds produced by a sound source, wherein the first audio input device converts the first audio signal into a first digital audio signal;
a second audio input device including a second microphone for acquiring a second audio signal including the sounds produced by the sound source, wherein the second audio input device converts the second audio signal into a second digital audio signal, the second microphone is disposed close adjacent to the sound source, and a distance between the second microphone and the sound source is shorter than a distance between the first microphone and the sound source; and
an audio processing circuit for performing an echo cancellation process on the first digital audio signal according to the second digital audio signal so as to generate a digital audio detection signal.

2. The audio detection device of claim 1, wherein the second audio input device transmits the second digital audio signal to the audio processing circuit through wireless communications.

3. The audio detection device of claim 1, wherein the first audio input device further comprises:
a first analog to digital converter for converting the first audio signal into the first digital audio signal.

4. The audio detection device of claim 1, wherein the second audio input device further comprises:
a second analog to digital converter for converting the second audio signal into the second digital audio signal; and
a first communication circuit for converting the second digital audio signal into a wireless transmission signal;
wherein the wireless transmission signal is transmitted to the audio processing circuit through wireless communications.

5. The audio detection device of claim 1, wherein the second audio input device converts the second digital audio signal into a wireless transmission signal transmitted to the audio processing circuit, and the audio processing circuit comprises:
a first communication circuit for receiving the wireless transmission signal transmitted by the second audio input device and converting the wireless transmission signal into the second digital audio signal; and
a processing circuit for performing the echo cancellation process on the first digital audio signal according to the second digital audio signal so as to generate the digital audio detection signal.

6. The audio detection device of claim 1, wherein the audio processing circuit delays the second digital audio signal for a delay time period, and performs the echo cancellation process on the first digital audio signal according to the delayed second digital audio signal so as to generate the digital audio detection signal.

7. The audio detection device of claim 6, wherein the delay time period is a difference between a sum of a transmission time of transmitting sound from the sound source to the first audio input device and a processing time of converting the first audio signal into the first digital audio signal by the first audio input device and a sum of a processing time of converting the second audio signal into the second digital audio signal by the second audio input device, a processing time of converting the second digital audio signal into the wireless transmission signal and emitting a wireless radio signal corresponding to the wireless transmission signal by the second audio input device, and a processing time of converting the wireless transmission signal into the second digital audio signal by the audio processing circuit.

8. An audio detection method for an audio detection device, the audio detection device comprising a first audio input device including a first microphone, a second audio input device including a second microphone, the second audio input device disposed close adjacent to a sound source, and a distance between the second microphone and the sound source is shorter than a distance between the first microphone and the sound source, the audio detection method comprising:
utilizing the first microphone to acquire a first audio signal including sounds produced by the sound source and utilizing the first audio input device to convert the first audio signal into a first digital audio signal;
utilizing the second microphone to acquire a second audio signal including the sounds produced by the sound source and utilizing the second audio input device to convert the second audio signal into a second digital audio signal; and
performing an echo cancellation process on the first digital audio signal according to the second digital audio signal so as to generate a digital audio detection signal.

9. The audio detection method of claim 8, further comprising:
utilizing the second audio input device to transmit the second digital audio signal to an audio processing circuit through wireless communications.

10. The audio detection method of claim 8, further comprising:
utilizing the second audio input device to convert the second digital audio signal into a wireless transmission signal; and
utilizing the second audio input device to transmit the wireless transmission signal to an audio processing circuit through wireless communications.

11. The audio detection method of claim 10, wherein the step of performing the echo cancellation process on the first digital audio signal according to the second digital audio signal so as to generate the digital audio detection signal comprises:
utilizing the audio processing circuit to receive the wireless transmission signal transmitted by the second audio input device and convert the wireless transmission signal into the second digital audio signal; and
performing the echo cancellation process on the first digital audio signal according to the second digital audio signal so as to generate the digital audio detection signal.

12. The audio detection method of claim 8, wherein the step of performing the echo cancellation process on the first digital audio signal according to the second digital audio signal so as to generate the digital audio detection signal comprises:
delaying the second digital audio signal for a delay time period and performing the echo cancellation process on the first digital audio signal according to the delayed second digital audio signal so as to generate the digital audio detection signal.

13. The audio detection method of claim 12, wherein the delay time period is a difference between a sum of a transmission time of transmitting sound from the sound source to the first audio input device and a processing time of converting the first audio signal into the first digital audio signal by the first audio input device and a sum of a processing time of converting the second audio signal into the second digital audio signal by the second audio input device, a processing time of converting the second digital audio signal into the wireless transmission signal and emitting a wireless radio signal corresponding to the wireless transmission signal by the second audio input device and a processing time of converting the wireless transmission signal into the second digital audio signal by an audio processing circuit.

14. An audio detection device, comprising:
a first audio input device for acquiring a first audio signal and converting the first audio signal into a first digital audio signal;
a second audio input device for acquiring a second audio signal and converting the second audio signal into a second digital audio signal, wherein the second audio input device is disposed close adjacent to a sound source, and a distance between the second audio input device and the sound source is shorter than a distance between the first audio input device and the sound source; and
an audio processing circuit for performing an echo cancellation process on the first digital audio signal according to the second digital audio signal so as to generate a digital audio detection signal;
wherein the audio processing circuit delays the second digital audio signal for a delay time period and performs the echo cancellation process on the first digital audio signal according to the delayed second digital audio signal so as to generate the digital audio detection signal, wherein the delay time period is a difference between a sum of a transmission time of transmitting sound from the sound source to the first audio input device and a processing time of converting the first audio signal into the first digital audio signal by the first audio input device and a sum of a processing time of converting the second audio signal into the second digital audio signal by the second audio input device, a processing time of converting the second digital audio signal into the wireless transmission signal and emitting a wireless radio signal corresponding to the wireless transmission signal by the second audio input device, and a processing time of converting the wireless transmission signal into the second digital audio signal by the audio processing circuit.
